(19) United States
(12) Patent Application Publication
(10) Pub. No.: US 2007/0047963 A1
(43) Pub. Date: Mar. 1, 2007

(54) Optical transceiver having parallel electronic dispersion compensation channels

(76) Inventor: John Dallesasse, Geneva, IL (US)

Correspondence Address: CHRISTIE, PARKER & HALE, LLP, PO BOX 7068, PASADENA, CA, 91109-7068, US

(21) Appl. No.: 11/212,822

(22) Filed: Aug. 25, 2005

(51) Int. Cl. H04B 10/12

(52) U.S. Cl. 398/147

(57) ABSTRACT

An optical receiver including a demultiplexer, a plurality of detectors and a plurality of electronic dispersion compensation (EDC) circuits. The demultiplexer demultiplexes an optical beam including a plurality of optical beam components having different wavelengths into separate optical beams. The plurality of detectors receive the optical beams and convert the optical beams to electrical signals. Each of the EDC circuits electronically compensates for optical dispersion of one of the optical beams corresponding to a respective one of the electrical signals.

### FIELD OF THE INVENTION

The present invention relates to the use of electronic dispersion compensation (EDC) in transceivers and receivers for optical fiber communication systems using wavelength-division multiplexing.

### BACKGROUND

A single mode fiber (SMF) has traditionally been used to transmit information on a single channel at a single wavelength. Wavelength Division Multiplexing (WDM) allows information to be transmitted in parallel on multiple channels in a SMF, with each channel centered on a separate wavelength. Thus the available bandwidth on a single fiber is greatly increased in WDM systems compared to traditional SMF-based systems. Wide or coarse WDM (CWDM) has also been applied to multi-mode fiber (MMF) systems to enable the deployment of higher-speed networks where MMF infrastructure already exists. Dense WDM (DWDM) with a larger number of channels is also used in such applications.

The ability of a WDM system to transmit information is limited in part by dispersion. Dispersion refers to a widening of optical pulses as they travel down the fiber. This widening causes inter-symbol interference (ISI) and cross-talk, by which optical signals in one channel can corrupt optical signals in adjacent channels. Dispersion also decreases the received power of an optical signal, which can cause the receiver to fail to detect the optical signal. These problems contribute to the bit error rate (BER) of the system. Since the effects of dispersion increase with fiber length, dispersion places a limit on the allowable length of the fiber. For a fixed fiber length, dispersion limits the maximum allowable data rate.

Types of dispersion include chromatic dispersion, polarization mode dispersion (PMD) and modal dispersion. The chromatic dispersion results from the fact that the refractive index of the fiber, and thus its propagation constant, is a function of wavelength. The optical signal on a channel in a WDM system is not monochromatic but rather includes a narrow band of wavelengths forming a signal pulse. Since the propagation constant is a function of wavelength, the different wavelengths that make up the signal pulse will travel at different speeds, again causing the signal pulse to widen as it travels down the optical fiber.

The chromatic dispersion can be compensated for by alternating a conventional fiber with a dispersion-compensating fiber (DCF). The DCF has a diffractive index profile which is nearly opposite to that of the conventional fiber. The dispersion induced by the standard fiber thus is cancelled by the dispersion induced by the DCF, potentially resulting in zero dispersion. However, the DCF diffractive index is not exactly matched to that of SMF. Therefore, the exact canceling of dispersion can only be accomplished for one wavelength, or channel, in a WDM system; other wavelengths will have non-zero dispersion. Further, zero dispersion is not desirable, because it increases non-linear interactions between channels, specifically, four-wave mixing. The DCF also has higher loss than a conventional fiber. The use of the DCF therefore increases the need to use regenerators to restore the optical signals.

Other methods for compensating for chromatic dispersion include chirped in-fiber Bragg gratings (FBGs) and nonlinear optical loop mirrors (NOLMs). In a chirped FBG, the refractive index of a section of fiber is varied along the length of the fiber to form a grating, such that different wavelengths within a channel are reflected at different depths within the grating, thereby compensating for dispersion. A single chirped FBG can only compensate for a single channel. A WDM system thus requires multiple FBGs, one for each channel. A NOLM includes a splitter and a resonant ring of dispersion-shifted fiber. A self-phase modulation in the nonlinear fiber results in an interference fringe shift that compensates for dispersion.

The PMD results from core non-circularity and optical birefringence in the fiber. Core non-circularity and birefringence cause the optical signal to travel faster along one axis of the fiber than along another axis. The optical signal effectively is separated into two optical signals traveling at different speeds down the fiber. The optical signal at the receiver thus is distorted compared to the input optical signal. The PMD is not a major contributor to overall dispersion at low bit rates for short fibers. It is a major contributor, however, at or above 40 Gb/s for long distances (e.g., >500 km). The PMD can be reduced by improving the circularity of fiber and can be partially compensated for by using highly polarized fiber. However, the PMD is much more difficult to compensate for than chromatic dispersion. No simple and inexpensive solution exists.

In MMF systems, differential mode delay (DMD) is the dominant source of dispersion that limits link length. The cause of DMD is the difference in propagation speed for distinct optical modes in multi-mode fiber. This modal distribution can be time-varying, resulting in a dynamic channel transfer function. In simple terms, when an optical signal is launched into a fiber, the rays that make up the optical signal are not perfectly parallel. The speed at which each ray travels down the fiber is a function of an angle at which the ray was launched into the fiber. A variation in that angle results in a variation in the speed of the rays, which causes the signal pulse to widen as it travels down the fiber. This problem is exacerbated at bends, defects, and by fiber dents. At such points, the mode pattern can change, resulting in a change in the DMD. The modal dispersion can be significantly reduced by careful design of optical components used to launch the signal into the fiber (control of launch conditions), but cannot be reduced to zero.

Dispersion compensation techniques such as those discussed above are used in dispersion-compensating modules (DCMs). DCMs monitor each channel and compensate each channel individually for dispersion. While DCMs reduce the effects of dispersion, they generally cannot reduce dispersion to zero. Also, as discussed above, a small amount of dispersion is desirable to reduce four-wave mixing. Further, the effectiveness of these techniques is limited in systems using optical add-drop multiplexers, because added signals and dropped signals have different dispersion characteristics.

As discussed above, optical techniques for dispersion compensation still result in non-zero dispersion and also can increase the loss of signal amplitude. Therefore, electronic dispersion compensation (EDC) is desirable in regenerators and receivers. EDC also permits the compensation of dispersion in channels with time-varying transfer functions through an adaptation algorithm.

Regenerators are required in long-haul systems due to the limit that dispersion and loss place on fiber length. Regenerators reshape, retime, and restore (i.e., amplify) weakened optical signals. Incoming optical signals are demultiplexed and converted to electrical signals. Noise, wander, and jitter are removed, signal amplitudes are restored, and pulse spectral shapes are adjusted to compensate for dispersion. The regenerated signals then are converted from electrical to optical and multiplexed onto the next length of optical fiber.

Receivers must correctly detect optical signals with degraded power, spectral, and noise content. Incoming multiplexed optical signals may pass through an optical preamplifier, a polarization filter, and a power equalizer. The multiplexed optical signals then are demultiplexed and converted to electrical signals. The clock is extracted from each signal and the required sampling time and threshold level needed to detect the signal are determined. Failure to detect the signal accurately despite its degraded condition results in increased BER.

A number of published U.S. patent applications disclose an implementation of EDC. By way of example, in U.S. Patent Application Publication No. 2004/0258181, Popescu et al. disclose a receiver with EDC including circuits to compensate for pulse distortion and to set the optimal eye sampling time when a distorted signal is received. Further, in U.S. Patent Application Publication No. 2003/0011847, Dai et al. disclose a receiver including at least one optical device for compensating distortion in a channel of an optical signal, at least one photodetector circuit for converting the optical signal into an electrical signal, and at least one electronic device for further compensating the distortion in the electronic signal. However, there is no disclosure in these references for providing EDC in each of parallel channels.

The EDC is also implemented in a number of optical communications products available in the market today. By way of example, AMCC offers the S3394 SONET/SDH/FEC Receiver with dispersion compensation for 10 Gbps applications including DWDM networks. Also, Scintera Networks offers the SCN5028 Electronic Dispersion Compensation Engine for 10 Gbps applications. There also are a number of other manufacturers that offer products that incorporate EDC. However, there does not appear to be any product available in the market today that incorporates parallel EDC channels.

Since the WDM system processes multiple optical signals in parallel, it is desirable to provide a method and apparatus for providing EDC in parallel to the channels of the optical signals in a WDM system.

### SUMMARY

In an exemplary embodiment of the present invention, an optical receiver includes a demultiplexer for demultiplexing an optical beam including a plurality of optical beam components having different wavelengths into separate optical beams. A plurality of detectors receive the optical beams and convert them to electrical signals. A plurality of electronic dispersion compensation (EDC) circuits compensate for optical dispersion, wherein each of the EDC circuits electronically compensates for optical dispersion of one of the optical beams corresponding to a respective one of the electrical signals.

In another exemplary embodiment of the present invention, an optical transceiver includes a demultiplexer for demultiplexing an optical beam including a plurality of optical beam components having different wavelengths into separate first optical beams. A plurality of detectors receive the first optical beams and convert them to electrical signals. A plurality of electronic dispersion compensation (EDC) circuits compensate for optical dispersion, wherein each of the EDC circuits electronically compensates for optical dispersion of one of the first optical beams corresponding to a respective one of the electrical signals. A plurality of optical transmission channels transmit a plurality of second optical beams, and a multiplexer multiplexes the second optical beams into a multiplexed optical beam and transmits the multiplexed optical beam.

In yet another exemplary embodiment of the present invention, an optical transceiver includes a plurality of optical transmission channels for converting a plurality of electrical signals into a plurality of first optical beams having different wavelengths. A multiplexer multiplexes the first optical beams having different wavelengths into a multiplexed optical beam, and transmits the multiplexed optical beam. A demultiplexer demultiplexes a second optical beam including a plurality of optical beam components having different wavelengths into separate second optical beams. Each of the second optical beams is dispersion compensated electronically by a different one of electronic dispersion compensation (EDC) circuits.

In yet another exemplary embodiment of the present invention, a method of electronically compensating for dispersion of optical signals involves demultiplexing an optical beam including a plurality of optical beams having different wavelengths into separate optical beams, converting the optical beams to electrical signals, and electronically compensating for optical dispersion of the optical beams corresponding to the electrical signals, wherein electronic dispersion compensation is performed on each of the electrical signals separately from other ones of the electrical signals.

### BRIEF DESCRIPTION OF THE DRAWINGS

FIG. 1 is a block diagram of an optical transceiver in one exemplary embodiment of the present invention.

### DETAILED DESCRIPTION

Exemplary embodiments of the present invention are directed to electronic dispersion compensation (EDC) in Wavelength Division Multiplexing (WDM) optical fiber communication systems. In the exemplary embodiments, multiple EDC circuits are provided in an optical transceiver, such that each of the optical beam components of a wavelength-division multiplexed optical beam can be dispersion compensated by a corresponding one of the EDC circuits, rather than having a single EDC circuit perform dispersion compensation for the whole wavelength-division multiplexed optical beam.

In one embodiment, a transceiver 10 has four XFI serial electrical interface ports 20a-d for receiving electrical signals using such protocols as 10 Gb/s Ethernet, 10 Gb/s Fiber Channel, OC-192 SONET, or any other suitable protocols. The electrical signals received over the XFI serial electrical interface are in digital format (i.e., digital data signals). The ports receive separate electrical signals and transmit the signals to respective clock and data recovery (CDR) circuits 22a-d. The architecture and operation of CDR circuits are known to those skilled in the art.

The CDR circuits recover the clock and data from the digital electrical signals and transmit the data to respective laser drivers 24a-d. The laser drivers 24a-d convert the digital electrical signals into analog electrical signals suitable for directly driving lasers. Accordingly, the laser drivers 24a-d modulate laser diodes 26a-d and thereby convert the analog electrical signals to optical beams. Each optical beam is centered about a separate specified wavelength λ1-λ4. An optical multiplexer 28 combines the separate optical beams into a single wavelength-division multiplexed optical beam that is output onto an optical fiber 30. The architectures and operations of the laser drivers, laser diodes and the optical multiplexer are known to those skilled in the art.

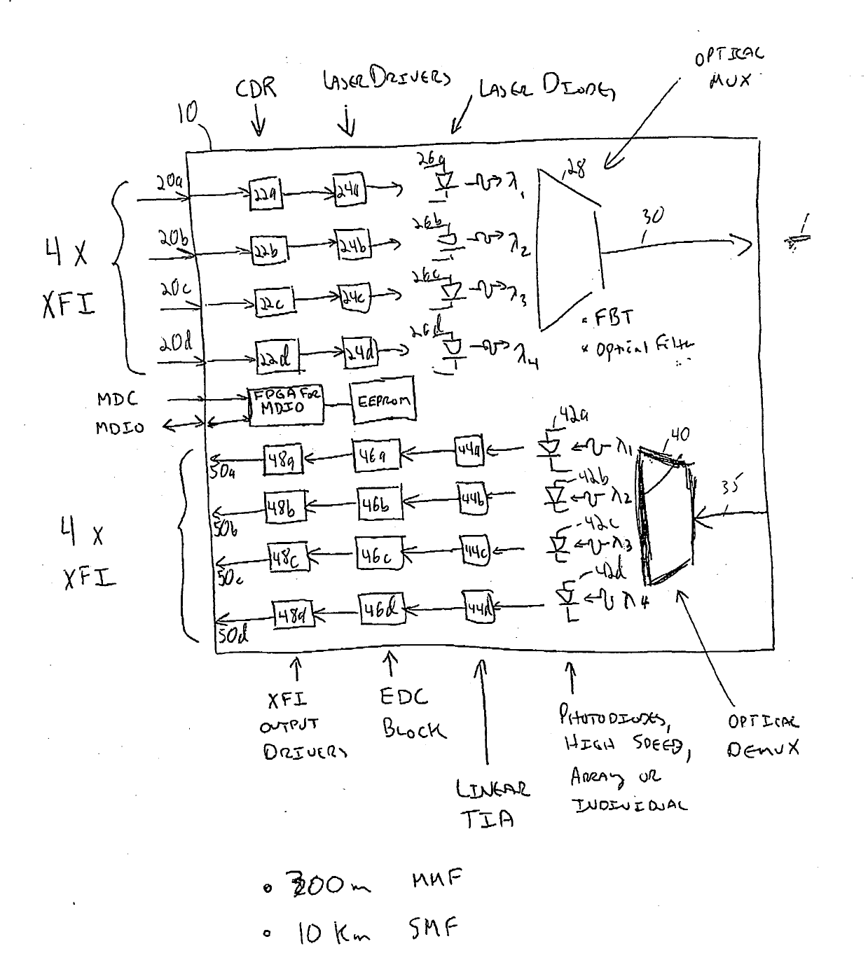

The transceiver 10 of FIG. 1, by concurrently transmitting four signals (in a multiplexed form), each with a bandwidth of 10 Gb/s, achieves an effective bandwidth of 40 Gb/s using a single optical fiber. In other embodiments, more than four channels may be used in a transceiver such that the bandwidth of the optical fiber is increased corresponding to the number of channels. By way of example, when N channels are used, the effective bandwidth becomes N×(single channel bandwidth) wherein N is any suitable positive integer.

The transceiver 10 also receives an input from a second optical fiber 35 that transmits a wavelength-division multiplexed optical beam. An optical demultiplexer 40 demultiplexes or splits the incoming optical beam into its component beams centered about separate specified wavelengths λ1-λ4. While the wavelengths (i.e., λ1-λ4) of the component beams in the input and output wavelength-division multiplexed optical beams are the same, these wavelengths may be different in other embodiments. Also, there may be more than four optical component beams having different wavelengths that make up one or both of the wavelength-division multiplexed optical beams in other embodiments.

High-speed photodiode detectors 42a-d respectively convert the four demultiplexed optical beams (i.e., component beams having wavelengths λ1-λ4) to analog electrical signals, in an operation that is known to those skilled in the art. The photodiode detectors may include a single photodiode array, or may include an array of individual photodiodes. Linear transimpedance amplifiers 44a-d convert the analog electrical signals from a current format to a voltage format and transmit the resulting voltage-formatted analog electrical signals to Electronic Dispersion Compensation (EDC) blocks 46a-d.

The received signals are likely to have been degraded by dispersion. The EDC blocks 46a-d restore the electrical signals by compensating for the effects of dispersion. Each EDC block may process the analog electrical signals in the corresponding channel into a digital electrical signal (i.e., digital data signal) during which the dispersion caused in the optical fiber may be compensated.

By way of example, as a part of the dispersion compensation, noise, wander, and jitter may be removed, signal amplitudes may be restored, and pulse spectral shapes may be adjusted. This compensation is performed individually for each of the electrical signals corresponding to the component optical beams by its respective EDC block 46a, 46b, 46c or 46d. The architecture and operation of the EDC blocks are known to those skilled in the art.

While only four EDC blocks 46a-46d are used in the transceiver 10 to provide dispersion compensation for four optical component beams, the number of EDC blocks are not limited thereto. The number of EDC blocks according to the principles of the invention would be the same as the number of component optical beams in the wavelength-division multiplexed beam received by the receiver part of the transceiver.

The restored signals are transmitted to XFI output drivers 48a-d, which format the respective electrical signals from the EDC blocks into a format suitable for transmission via the XFI interface ports, and output the formatted electrical signals via respective XFI interface ports 50a-d. The architecture and operation of the XFI output drivers are known to those skilled in the art.

Hence, in exemplary embodiments according to the present invention, each channel of a receiver in an optical transceiver has its own EDC block for dispersion compensation. This way, an electronic dispersion is performed on an electrical signal corresponding to a single wavelength signal received into the channel. This way, dispersion caused by the optical fiber in different component signals having different wavelengths can be compensated separately and differently from each other.

It will be appreciated by those of ordinary skill in the art that the invention can be embodied in other specific forms without departing from the spirit or essential character thereof. The present description is therefore considered in all respects to be illustrative and not restrictive. The scope of the invention is indicated by the appended claims, and all changes that come within the meaning and range of equivalents thereof are intended to be embraced therein.

What is claimed is:

1. An optical receiver comprising:
a demultiplexer for demultiplexing an optical beam comprising a plurality of optical beam components having different wavelengths into separate optical beams;
a plurality of detectors for receiving the optical beams and for converting the optical beams to electrical signals; and
a plurality of electronic dispersion compensation (EDC) circuits, wherein each of the EDC circuits electronically compensates for optical dispersion of one of the optical beams corresponding to a respective one of the electrical signals.

2. The optical receiver of claim 1, further comprising a plurality of transimpedance amplifiers (TIAs), each TIA coupled between a corresponding one of the detectors and a corresponding one of the EDC circuits to convert the electrical signals from a current format to a voltage format.

3. The optical receiver of claim 1, further comprising a plurality of output drivers coupled to the EDC circuits for receiving outputs of the EDC circuits and for outputting the outputs of the EDC circuits.

4. The optical receiver of claim 1, wherein the detectors comprise photodiodes.

5. The optical receiver of claim 4, wherein the detectors comprise a photodiode array.

6. The optical receiver of claim 4, wherein the detectors comprise an array of individual photodiodes.

7. An optical transceiver comprising:
a demultiplexer for demultiplexing an optical beam comprising a plurality of optical beam components having different wavelengths into separate first optical beams;
a plurality of detectors for receiving the first optical beams and for converting the first optical beams to electrical signals;
a plurality of electronic dispersion compensation (EDC) circuits, wherein each of the EDC circuits electronically compensates for optical dispersion of one of the first optical beams corresponding to a respective one of the electrical signals;
a plurality of optical transmission channels for transmitting a plurality of second optical beams; and
a multiplexer for multiplexing the second optical beams into a multiplexed optical beam, and for transmitting the multiplexed optical beam.

8. The optical transceiver of claim 7, wherein each of the optical transmission channels includes a clock and data recovery (CDR) unit, laser driver and a laser diode.

9. An optical transceiver comprising:
a plurality of optical transmission channels for converting a plurality of electrical signals into a plurality of first optical beams having different wavelengths;
a multiplexer for multiplexing the first optical beams having different wavelengths into a multiplexed optical beam, and for transmitting the multiplexed optical beam; and
a demultiplexer for demultiplexing a second optical beam comprising a plurality of optical beam components having different wavelengths into separate second optical beams,
wherein each of the second optical beams is dispersion compensated electronically by a different one of electronic dispersion compensation (EDC) circuits.

10. A method of electronically compensating for dispersion of optical signals, the method comprising:
demultiplexing an optical beam comprising a plurality of optical beams having different wavelengths into separate optical beams;
converting the optical beams to electrical signals; and
electronically compensating for optical dispersion of the optical beams corresponding to the electrical signals, wherein electronic dispersion compensation is performed on each of the electrical signals separately from other ones of the electrical signals.
